(19) United States
(12) Patent Application Publication
(10) Pub. No.: US 2023/0379369 A1
(43) Pub. Date: Nov. 23, 2023

(54) TECHNOLOGIES FOR PROVIDING INTERNET PROTOCOL MULTIMEDIA SUBSYSTEM SERVICES

(71) Applicant: Apple Inc., Cupertino, CA (US)

(72) Inventors: Rohit R. Matolia, Bengaluru (IN); Vijay Venkataraman, San Jose, CA (US); Alosious Pradeep Prabhakar, Singapore (SG)

(73) Assignee: Apple Inc., Cupertino, CA (US)

(21) Appl. No.: 18/320,875

(22) Filed: May 19, 2023

(30) Foreign Application Priority Data
May 20, 2022 (IN) 202241029180

(51) Int. Cl. H04L 65/1073; H04L 65/1016; H04W 60/00

(52) U.S. Cl. CPC H04L 65/1073; H04L 65/1016; H04W 60/00; H04W 84/042

(57) ABSTRACT

The present application relates to devices and components including apparatus, systems, and methods for providing Internet protocol multimedia subsystem services.

### CROSS-REFERENCE TO RELATED APPLICATION

This application claims the benefit of India Patent Application No. 202241029180, filed on May 20, 2022, which is herein incorporated by reference in its entirety for all purposes.

### BACKGROUND

Third Generation Partnership Project (3GPP) Technical Specifications (TSs) define standards related to Long Term Evolution (LTE) and New Radio (NR) wireless networks. User equipments (UEs) operating within these networks may need to coordinate access of data and voice services from these networks.

### BRIEF DESCRIPTION OF THE DRAWINGS

FIG. 1 illustrates a network environment in accordance with some embodiments.

FIG. 2 illustrates a flow diagram in accordance with some embodiments.

FIG. 3 illustrates another flow diagram in accordance with some embodiments.

FIG. 4 illustrates an operation flow/algorithmic structure in accordance with some embodiments.

FIG. 5 illustrates a call flow in accordance with some embodiments.

FIG. 6 illustrates another operation flow/algorithmic structure in accordance with some embodiments.

FIG. 7 illustrates another operation flow/algorithmic structure in accordance with some embodiments.

FIG. 8 illustrates another operation flow/algorithmic structure in accordance with some embodiments.

FIG. 9 illustrates another operation flow/algorithmic structure in accordance with some embodiments.

FIG. 10 illustrates a UE in accordance with some embodiments.

FIG. 11 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

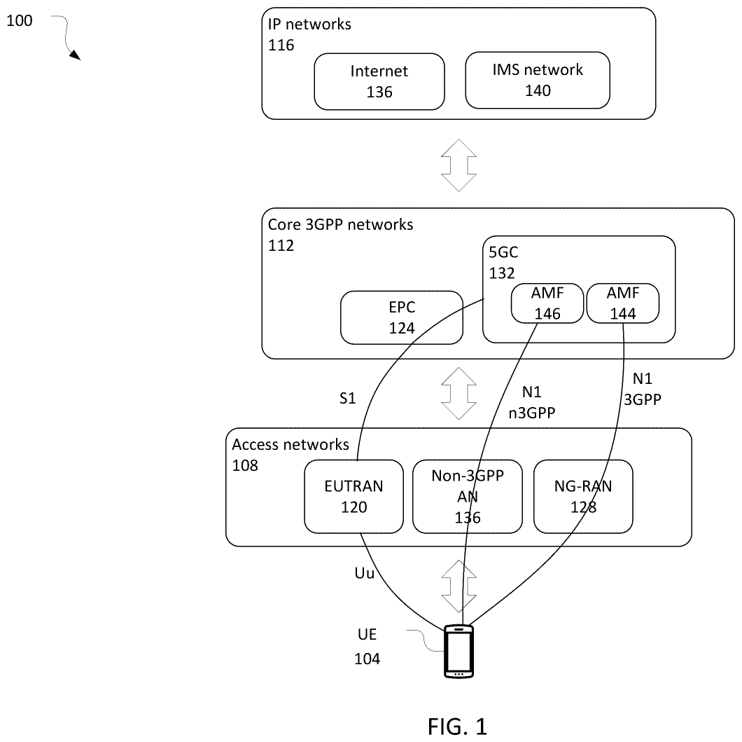

FIG. 1 illustrates a network environment 100 in accordance with some embodiments. The network environment 100 may include a UE 104, access networks 108, core 3GPP networks 112, and Internet protocol (IP) networks 116.

The access networks 108 may provide the UE 104 with wireless access to the core 3GPP networks 112. The access networks may include 3GPP access networks compatible with various generations of 3GPP TSs. For example, the access networks 108 may include an evolved universal terrestrial radio access network (E-UTRAN) 120 and a next-generation-radio access network (NG-RAN) 128.

The E-UTRAN 120 may provide the UE 104 with access to an evolved packet core (EPC) 124 or 5GC 132 of the core 3GPP networks 112. The E-UTRAN 120 may be provided by a 4^{th} Generation (4G) LTE base station, for example, an evolved node B (eNB). The EPC 124 and EUTRAN 120 may be collectively referred to as an evolved packet system (EPS).

The NG-RAN 128 may provide the UE 104 with access to the EPC 124 or a 5^{th} Generation core network (5GC) 132 of the core 3GPP networks 112. The NG-RAN 128 may be provided by a 5^{th} Generation (5G) NR base station, for example, a next-generation node B (gNB). The NG-RAN 128 and the 5GC 132 may be collectively referred to as a 5G system (5GS). While embodiments are described with respect to 5GS, similar concepts may also be applicable to later generations such as, for example, 6^{th} generation (6G) networks.

The access networks 108 may further include a non-3GPP access network (AN) 136. The non-3GPP AN 136 may provide the UE 104 with access to the EPC 124 or the 5GC 132. The non-3GPP AN 136 may be a wireless local area network (WLAN) provided by an access point.

The core 3GPP networks 112 may have components/functions that provide services such as storing subscription information, authenticating user equipments (UEs)/network components, registering and tracking UEs, managing quality of service (QoS) aspects, controlling data sessions, and forwarding uplink/downlink traffic. The core 3GPP networks 112 may be coupled with IP networks 116 to communicate traffic to and from the UE 104. The IP networks 116 may include the Internet 136 for providing Internet services and an IP multimedia subsystem (IMS) network 140 for delivering IP multimedia services. The IMS network 140 may provide control plane functions to manage packet-switched voice services.

Communication within the network 100 may take place over a number of logical interfaces that are associated with a prescribed set of signaling procedures between the coupled components. The E-UTRAN 120 may communicate with the UE 104 via a Uu interface and the EPC 124 via an S1 interface. The UE 104 may communicate with access and mobility functions (AMFs) 144 and 146 of the 5GC 132 via N1 interfaces. The N1 interfaces may traverse through the non-3GPP AN 136 or the NG-RAN 128. The UE 104 may be in an S1 mode when it is communicating with the EPC 124 or 5GC 132 via the S1 interface, and may be in an N1 mode when it is communicating with the 5GC 132 via the N1 interface (through the non-3GPP AN 136 or the NG-RAN 128). The air interface between the UE 104 and the non-3GPP AN 136 may be outside the scope of 3GPP TSs and may be defined in accordance with other technologies such as, for example, Institute of Electrical and Electronics Engineers 802.11 technical standards.

A 5G network may be implemented as a standalone (SA) network or a non-standalone (NSA) network. A 5G SA network may include a gNB coupled with a 5GC, while a 5G NSA network may include a gNB coupled with an E-UTRAN.

Many 5G SA networks rely on EPS fallback for IMS voice services. For example, a UE operating in N1 mode via a 5G SA network may fallback to EPS for IMS voice services. In some instances, the UE may disable EUTRA/S1 capability. This may happen when an abnormal condition (based on far cell lower layer failure or temporary failure) on a EUTRAN is detected, which may lead to an attach or tracking area update (TAU) failure or rejection. When EUTRA/S1 is disabled, the UE may start a T3402 timer for 12 minutes. As the T3402 timer runs, the UE may send a registration request to the 5G SA network. The registration request may be voice centric if the UE is a phone. The 5G SA network may respond with a registration accept message that may indicate IMS over 3GPP is not allowed. As voice is a mandatory requirement for the voice-centric UE it may search for 2G/3G networks to support IMS voice services. If such networks are not available (from UE or network perspective), the IMS voice call may fail. To avoid the UE continuing to retry IMS protocol data unit (PDU) transmissions and calls in 5G (as the failures may be unknown to the UE), the 5G SA NW may disable 5G services. However, without 2G/3G network or network without CS network, the UE may remain in limited service and continue to scan for different public land mobile networks (PLMNs) without service until the T3402 timer expires and it may send another registration request. This may be the case even if there is non-3GPP access available. There may also be concerns related to emergency call failures or delays due to the EUTRA/S1 being disabled.

To address these issues, embodiments configure the UE 104 in a manner that allows IMS voice service support or network usability in various scenarios. In a first aspect, the UE 104 using the non-3GPP AN 136 to provide IMS services when the non-3GPP access available from the perspective of the UE 104 and the network. In a second aspect, the UE 104 uses a lower priority PLMN in roaming scenarios for voice services, if available. In a third aspect, if the UE 104 determines that no calling is available anywhere, it may change its usage setting from voice centric to data centric to allow the UE 104 to avail data services. In a fourth aspect, the UE 104 may utilize an exception to reenable EUTRA/S1 in order to avoid loops of requests. In a fifth aspect, the UE 104 may utilize a preference change between voice centric and data centric. In a sixth aspect, provisioning of emergency services and retry mechanisms may be provided to handle S1 disabled scenarios. In a seventh aspect, the UE 104 may re-disable EUTRA/S1 in the event enablement causes issues. These and other aspects will be described in further detail herein.

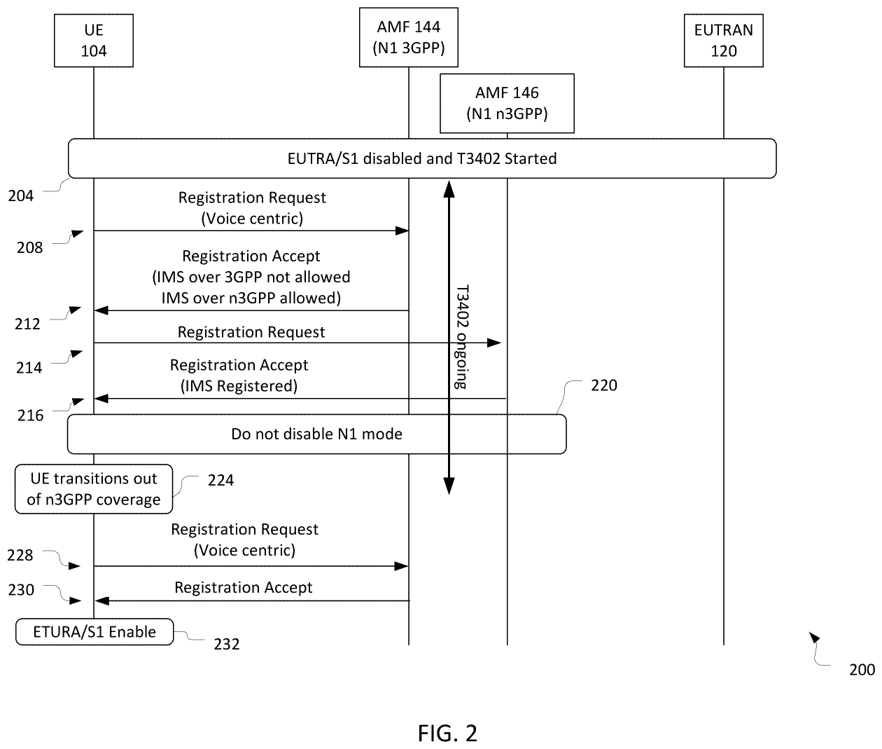

FIG. 2 is a flow diagram 200 that illustrates a procedure for accessing IMS voice services via non-3GPP access in accordance with some embodiments. Flow diagram 200 may generally correspond to aspect 1 and may ensure voice services for the UE 104 when non-3GPP access is available for voice and EPS fallback is not an option, and enabling S1 services when the UE 104 moves out of non-3GPP access voice service availability. This may enable the UE 104 to obtain slice-specific services and voice services while being connection to the 5GC 132.

Initially, the UE 104 may be configured with a noEUTRADisablingIn5GS information element (IE) set to indicate that the UE can enable EUTRA/S1 capability when the UE 104 is connected with a 5GS. The NoEUTRADisablingIn5GS IE may be set to ‘1’ to provide such an indication.

The flow diagram 200 may include, at 204, disabling the EUTRA/S1 capability of the UE 104 and starting a T3402 timer. The EUTRA/S1 capability may be disabled due to the UE 104 detecting an abnormal condition on the EUTRAN 120. This may be for reasons similar to those described in clause 4.5 of 3GPP TS 24.301 v17.6.0 (2022-03). These reasons may include, but are not limited to, far cell lower layer failures and temporary failures. Disabling the EUTRA/S1 capability, as used herein, may also be referred to as disabling the S1 mode.

The flow diagram 200 may further include, at 208, the UE 104 sending a registration request to the AMF 144 over the N1 3GPP interface (for example, through the NG-RAN 128). If the UE 104 is a voice-centric device, for example, a phone, the registration request may include a UE's usage setting IE to indicate the UE 104 supports IMS voice.

In response to the registration request, the AMF 144 may transmit a registration accept message at 212. The registration accept message may include an IMS voice over packet switched (PS) session over 3GPP access (IMS-VoPS-3GPP) indicator that indicates IMS voice over PS session not supported over 3GPP access. The registration accept message may further include an IMS voice over PS session over non-3GPP access indicator (IMS-VoPS-N3GPP) that indicates IMS voice over PS session supported over non-3GPP access.

At 214, the UE 104 may send a registration request message to the AMF 146 over the N1 n3GPP interface (for example, through the non-3GPP AN 136). At 216, the UE 104 may receive a registration accept message from the AMF 146 over the N1 n3GPP interface (for example, through the non-3GPP AN 136).

At 220, the UE 104 may not disable the N1 mode. This is in contrast to operation of voice-centric devices in previous networks in the event IMS over 3GPP is not allowed. Instead, the UE 104 may utilize the N1 n3GPP interface for IMS voice services, and may utilize the N1 3GPP interface for PDU/slice session services that may not be available via the N1 n3GPP interface.

If the UE transitions out of n3GPP coverage at 224, and the T3402 expires, the UE 104 may, at 228, send another voice-centric registration request to the AMF 144 via the N1 3GPP interface. At 230, the UE 104 may receive a registration accept message from the AMF 144 and may then re-enable the S1 EUTRA interface at 232.

In some embodiments, clause 4.3.2 of 3GPP TS 24.501 may be updated to accommodate the procedure illustrated by flow diagram 200. For example, this clause may be updated to reflect that, if UE S1 mode is disabled, T3402 timer is active, IMS over 3GPP not available, but IMS voice over non-3GPP is available and registered, a UE may not re-enable the S1 mode until the T3402 timer expires or the UE no longer is in coverage of the non-3GPP AN.

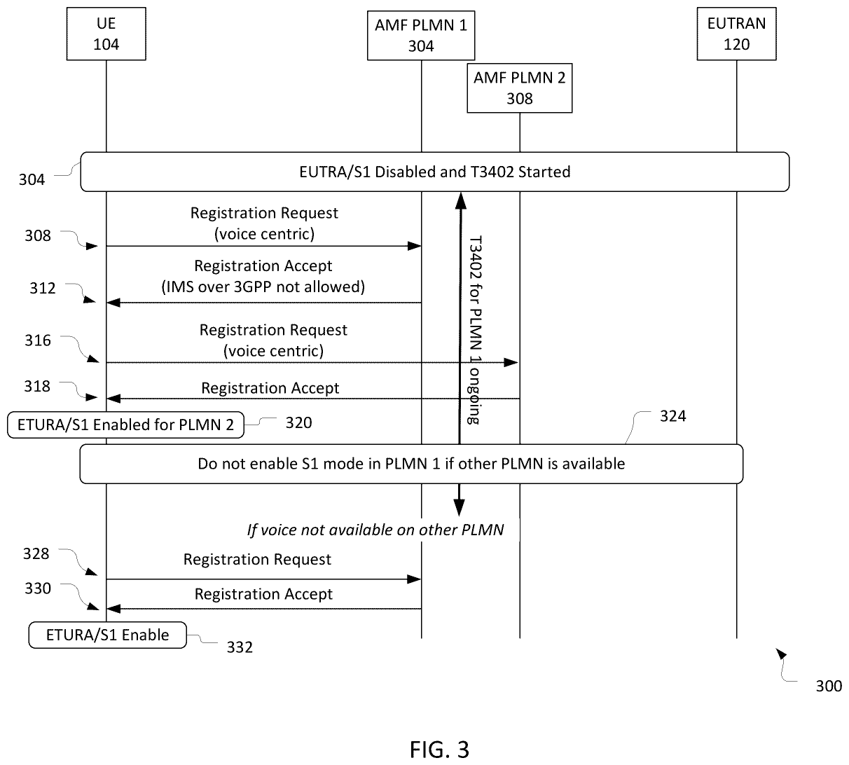

FIG. 3 is a flow diagram 300 that illustrates a procedure for EUTRA/S1 disabling in roaming scenarios in accordance with some embodiments. Flow diagram 300 may generally correspond to aspect 2 and may provide a mechanism to not disable S1 mode globally, localize it to current registered PLMN (RPLMN) only while non RPLMN/home PLMN (HPLMN) are available for services. If none of the other PLMNs can provide voice services, then the UE 104 may reenable S1 mode for service. This may help the UE 104 to get voice services on lower-priority PLMN, when higher priority networks have S1 disabled or abnormal 4G rejects.

In some embodiments, the flow diagram 300 may be associated with initial conditions that include the UE 104 roaming on a visited PLMN (VPLMN) or more than one equivalent HPLMNs (EHPLMNs) are available, the EUTRA/S1 is disabled for a registered PLMN (RPLMN) of the UE 104, and the UE 104 is configured with a noEUTRADisablingIn5GS IE set to indicate that the UE 104 can enable EUTRA/S1 capability when the UE 104 is connected with a 5GS.

The flow diagram 300 may include, at 304, disabling the EUTRA/S1 capability of the UE 104 and starting a T3402 timer. The EUTRA/S1 capability may be disabled due to the UE detecting an abnormal condition on the EUTRAN 120 as described elsewhere herein.

The flow diagram 300 may further include, at 308, the UE 104 sending a registration request to an AMF in a first PLMN (PLMN 1) via an N1 interface. PLMN 1 may be an RPLMN of the UE 104. If the UE 104 is a voice-centric device, for example, a phone, the registration request may include a UE's usage setting IE to indicate the UE 104 supports IMS voice.

In response to the registration request, the AMF in PLMN 1 may transmit a registration accept message at 312. The registration accept message may include an IMS-VoPS-3GPP indicator that indicates IMS voice over PS session not supported over 3GPP access.

At 316, the UE 104 may transmit another registration request to an AMF in a second PLMN (PLMN 2) via an N1 interface. The PLMN 2 may be an equivalent PLMN (EPLMN) with respect to the RPLMN, an EHPLMN with respect to the RPLMN, or a preferred PLMN (PPLMN). Similar to the registration request at 308, the registration request at 316 may include a UE's usage setting IE to indicate the UE 104 supports IMS voice.

The UE 104 may receive a registration accept message at 318 and may enable the EUTRA/S1 capability for the PLMN 2 at 320.

At 324, the UE 104 may not enable the S1 mode for the PLMN 1 (for example, the RPLMN) if the PLMN 2 is available.

If the T3402 timer for PLMN 1 expires and there is not IMS voice available from another PLMN, the flow diagram 300 may include transmitting another registration request to the AMF of PLMN 1 at 328.

At 330, the UE 104 may receive a registration accept. Based on the accepted registration and expiration of the T3402 timer, the EUTRA/S1 capability may be re-enabled for the PLMN 1 at 332.

Thus, in this embodiment, if the UE 104 has an S1 mode disabled in RPLMN, active T3402, an IMS over 3GPP not available indication, but determines an EPLMN/EHPLMN/PPLMN is available, the UE 104 may: not re-enable the S1 mode for the current RPLMN until T3402 timer for the RPLMN expires; stay in S1 mode for another PLMN selection; and, if no other PLMN voice-centric registration is accepted (with EUTRA/S1 capability enabled for the other PLMN), then the UE 104 may re-enable the S1 mode for the RPLMN.

In this manner, the UE 104 may gain voice services on another EHPLMN/EPLMN or low priority PLMN while roaming.

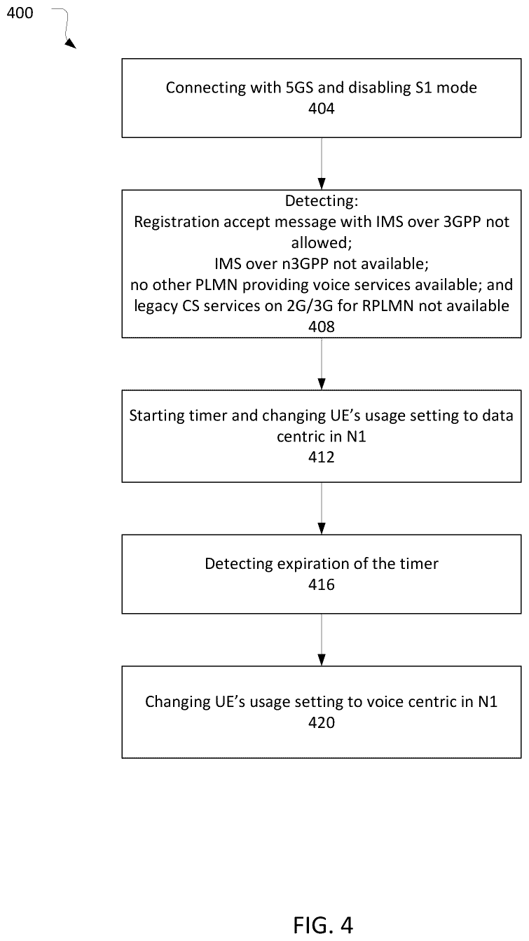

FIG. 4 is an operation flow/algorithmic structure 400 for transitioning between voice-centric and data-centric usage settings in accordance with some embodiments. The operation flow/algorithmic structure 400 may be implemented by the UE 104 or 1000; or components thereof such as processors 1004.

The operation flow/algorithmic structure 400 may generally correspond to aspect 3 and may include switching between voice- and data-centric usage settings to gain slice-specific services when S1 mode is disabled. This may play a supporting role to aspects 1 and 2. The UE may optionally gain data-centric services instead of re-enabling S1 mode.

The operation flow/algorithmic structure 400 may include, at 404, the UE being connected with a 5GS with S1 mode disabled. The S1 mode may be disabled for reasons described elsewhere herein.

The operation flow/algorithmic structure 400 may further include, at 408, detecting a set of initial conditions. The set of initial conditions may, collectively, indicate that the UE may not be able to access IMS voice services for at least a period of time.

The set of initial conditions may include receipt of a registration accept message with a IMS-VoPS-3GPP indicator that indicates IMS voice over PS over 3GPP is not available.

The set of initial conditions may further include IMS voice over non-3GPP access not being available. This condition may be true if a non-3GPP AN is available but is not able to support IMS services either because of the connection itself or a network setting, or if no non-3GPP AN is available.

The set of initial conditions may further include no other PLMN providing voice services at the UE's location being available.

The set of initial conditions may further include legacy CS services on 2G/3G for RPLMN not being available.

After detecting the set of initial conditions, the operation flow/algorithmic structure 400 may include starting a timer and changing a UE's usage setting to data centric in N1. In some embodiments, the UE may transmit an explicit indication that it is to operate as a data-centric UE, or it may simply operate as a data-centric UE without informing the network or attempting to access IMS voice services.

The timer set at 412 may be a UE implementation-dependent timer. The timer may be set with a value that is less than an active T3402 timer. In some embodiments, the timer may use a backoff timer value if such a value is provided by the network in a registration accept message.

The operation flow/algorithmic structure 400 may further include, at 416, detecting an expiration of the timer. After the timer expires, the operation flow/algorithmic structure 400 may include changing the UE's usage setting from data centric back to voice centric at 420. This may be done in a manner similar to that discussed above with respect to changing the usages setting to data centric.

In this manner, the UE may be able to retain data services another slice-specific applications while waiting for the IMS voice services to become available.

In some embodiments, if an emergency call or public warning system signal is detected while the UE has a data-centric usage setting, the UE may transition back to a voice-centric usage setting.

Clause 4.3.3 of TS 24.501 may be updated to reflect change of UE's usage setting as described herein. For example, the content of Table 1 may be added to table 4.3.3.1 of TS 24.501.

TABLE 1

| UE's usage setting change | Procedure to execute |
|---|---|
| From “voice centric” to “data | Keep the S1 mode capability |
| centric” and the S1 mode capability for | disabled for 3GPP access, enable |
| 3GPP access is disabled at the UE | after backoff timer expiry (UE |
| | or NW driven) |
| From “data centric” to “voice | Re-enable the S1 mode |
| centric” and the S1 mode capability for | capability for 3GPP access |
| 3GPP access is disabled at the UE | |

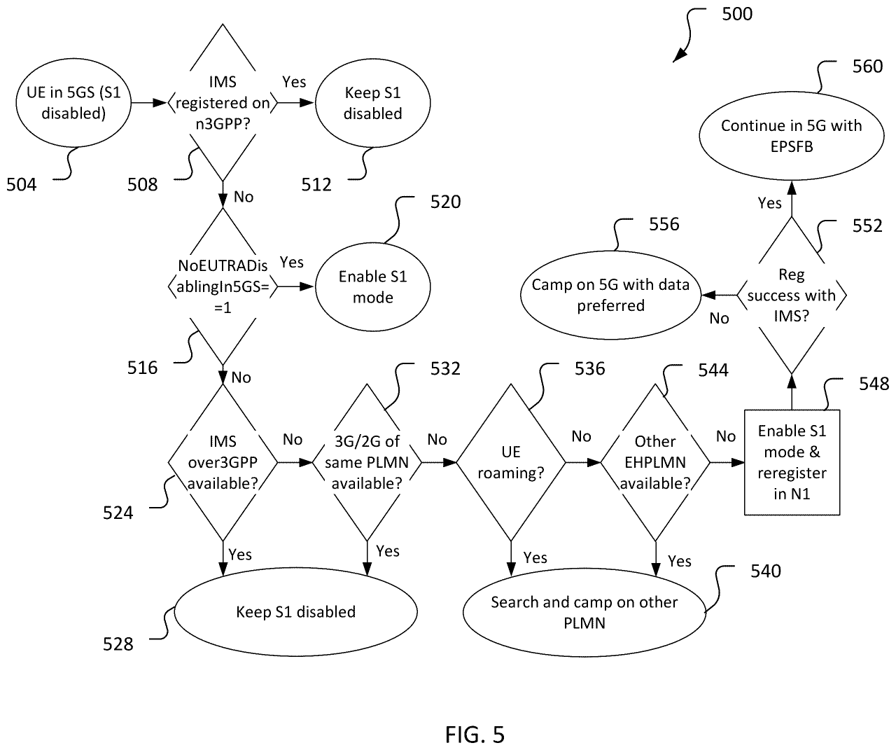

The aspects embodied by FIGS. 2-4 may be implemented individually or in combination with one another. FIG. 5 illustrates a unified call flow 500 in which the aspects of FIGS. 2-4 are implemented in combination with one another in accordance with some embodiments.

The call flow 500 may include starting a UE in 5GS with an S1 mode disabled at 504. At this time, the EUTRA may be disabled, the T3402 may be started, and the UE may be trying to register for voice on a 5G SA network. In general, this starting condition may be similar to that described above with respect to FIG. 4, for example.

The call flow 500 may further include determining whether IMS voice service is registered on non-3GPP at 508. If it is determined that IMS voice services over non-3GPP are available and the UE is registered on non-3GPP, the UE may keep EUTRA/S1 disabled and access the IMS voice services via a non-3GPP AN. If the IMS voice services no longer become available via the non-3GPP AN (and T2304 is not active), the UETRA/S1 may be re-enabled. This operation may be similar to that described above with respect to FIG. 2.

If it is determined, at 508, that IMS voice services is not registered on non-3GPP, the call flow 500 may advance to determining whether the NoEUTRADisablingIn5GS is set equal to ‘1,’ at 516. If the NoEUTRADisablingIn5GS is set equal to ‘1,’ it may indicate that the UE can enable EUTRA/S1 capability when connected with 5GS. In this instance, the call flow 500 may advance to enabling S1 mode at 520.

If the NoEUTRADisablingIn5GS is set equal to ‘0,’ it may indicate that the UE cannot enable EUTRA/S1 capability when connected with 5GS and the call flow 500 may advance to determining whether IMS voice over 3GPP is available at 524. This may be based on an indication in a 5G SA registration accept message. If the IMS voice over 3GPP is available, the call flow 500 may advance to keeping the S1 disabled at 528.

If the IMS voice over 3GPP is not available, the call flow 500 may advance to determining whether a 3G or 2G network of the same PLMN is available for voice services. If there is a 3G/2G option for voice services, the call flow may advance to keeping the S1 disabled at 528.

If there is no 3G/2G option for voice services, the call flow may advance to determining whether the UE is roaming at 536. If the UE is roaming, the call flow 500 may advance to searching and camping on another PLMN. This may be done consistent with PLMN selection described in 3GPP TS 23.122 v17.6.0 2022-03-22.

If the UE is not roaming, the call flow 500 may advance to determining whether another EHPLMN is available at 544. If there is another EHPLMN available, the call flow may advance to searching and camping on other PLMN (for example, the available EHPLMN) at 540.

If it is determined there is no other EHPLMN available at 544, the call flow 500 may advance to enabling S1 mode and re-attempting an N1 mode registration with IMS voice services. In some instances, this may include suspending a T3402 timer if active.

The call flow 500 may advance to determining whether the N1 mode registration with IMS voice services at 552. If the registration was successful with IMS voice services, the call flow 500 may advance to continuing in 5G with EPS fallback. If the registration was not successful, the call flow 500 may advance to camping on 5G (for example, on the high priority PLMN) with data preferred (for example, having the UE's usage setting as data centric) at 556.

In some situations, a back-to-back enable/disable loop may occur. Consider the initial conditions to be EUTRA/S1 disabled, T3402 timer started for 12 minutes, 2G/3G fallback not available, the network supports only EPS fallback, and NoEUTRADisablingIn5GS set to 1 or T3402 disabled in N1. T3402 may be disabled by the UE when it moves to N1/5G (with S1/EUTRA disabled) and wishes to access services, even though they may not be available.

If the EUTRA/S1 was disabled and T3402 was started for certain reasons, a UE may not be able to get voice services and may get stuck in a loop of N1 enable/disable due to IMS over 3GPP not being available. These reasons may include the IMS voice not available and CS voice not available on E-UTRA; reject cause indicating cause #15 or E-UTRA not allowed; UE-initiated detach for EPS services; and prevention of unwanted handover or cell reselection from NG-RAN to E-UTRAN (consistent with clause 4.5 of 3GPP TS 24.301). The reject cause #15 may indicate there are no suitable cells in a location or tracking area and may be provided to the UE from a 4G network when the UE tries to make an EPS fallback call. If any of these reasons were the reason EUTRA/S1 was initially disabled, the UE may stay without voice or data and continue to retry between different technologies for voice services.

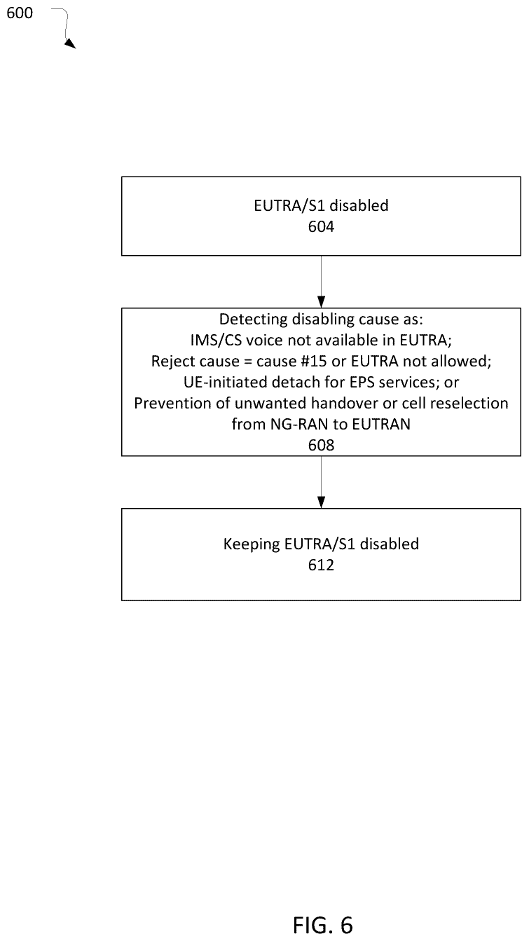

FIG. 6 illustrates an operation flow/algorithmic structure 600 to avoid loop requests and lack of voice services in accordance with some embodiments. The operation flow/algorithmic structure 600 may be implemented by the UE 104 or 1000; or components thereof such as processors 1004.

The operation flow/algorithmic structure 600 may generally correspond to aspect 4 and may help to avoid loop back and unnecessary scans/battery drain by attempting re-enabling of S1 mode after certain reasons for which the S1 mode was initially disabled. This may help to preserve the UE battery and provide some services when others may not be available.

The operation flow/algorithmic structure 600 may start at 604 with EUTRA/S1 being disabled. The T3402 timer may be started for 12 minutes. Further starting conditions may include 2G/3G fallback not being available, the network supporting only EPS fallback, and NoEUTRADisablingIn5GS being set to ‘1’ or T3402 disabled in N1.

The operation flow/algorithmic structure 600 may then include, at 608, detecting a cause for disabling the EUTRA/S1 as: IMS voice not available and CS voice not available on EUTRA; reject cause indicates cause #15 or EUTRA not allowed; UE-initiated detach for EPS services; or prevention of unwanted handover or cell reselection from NG-RAN to E-UTRAN (consistent with clause 4.5 of 3GPP TS 24.301). Clause 4.5 of 3GPP TS 24.301 provides that when a UE supporting N1 mode together with S1 mode needs to stay in N1 mode it shall disable the EUTRA capability to prevent unwanted handover or cell reselection from NG-RAN to E-UTRAN.

Re-enabling the EUTRA/S1 when the disabled cause is one of the fore mentioned causes may be associated with a high risk of having to disable EUTRA/S1 again for the same reason. Thus, when one of these causes is detected, the operation flow/algorithmic structure 600 may further include, at 612, keeping the EUTRA/S1 disabled. This may keep the UE out of the enable/disable loop and allow the UE to at least have data services available in N1 mode when voice services are not available.

In some embodiments, if the prevention of unwanted handover or cell reselection from NG-RAN to E-UTRAN is the disable cause, it may further be conditioned on the UE/network having Voice over NR (VoNR) support to disable EUTRA/S1 mode. In some embodiments, prevention of unwanted handover or cell reselection may serve as the disable cause to results in keeping the EUTRA/S1 disabled (as described in FIG. 6) only if the UE/NW supports VoNR and EPS fallback is not supported and required.

In some embodiments, the UE may disable EUTRA/S1 if IMS services are ongoing in non-3GPP access. This may be done in order to avoid battery consumption. In some embodiments, this disable cause may additionally/alternatively used as the detected disabling cause at 608 that prompts the keeping of the EUTRA/S1 disabled at 612.

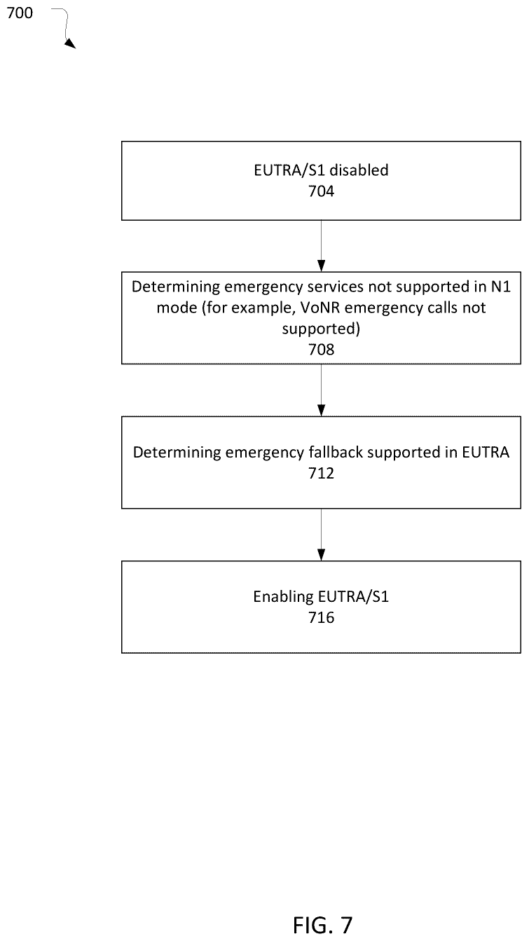

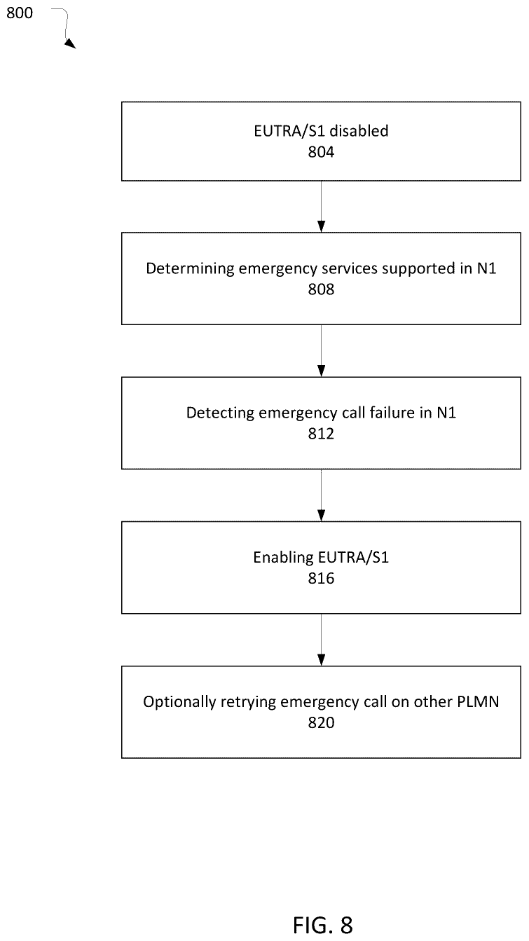

FIGS. 7 and 8 describe operation flows/algorithmic structures that generally correspond to aspect 6 and may be used to re-enable EUTRA in case emergency services are only supported in EUTRA and legacy 2G/3G services are not available, or in case emergency services is supported in 5G but a failure is observed. Re-enabling S1 mode may help to mitigate impact of emergency service availability to end user.

FIG. 7 illustrates an operation flow/algorithmic structure 700 that may be used for emergency services with EPS fallback in accordance with some embodiments. The operation flow/algorithmic structure 700 may be implemented by the UE 104 or 1000; or components thereof such as processors 1004.

The operation flow/algorithmic structure 700 may start at 704 with EUTRA/S1 being disabled. The T3402 timer may be started for 12 minutes. Further starting conditions may include 2G/3G fallback not being available.

The operation flow/algorithmic structure 700 may then include, at 708, determining that emergency services are not supported in N1 mode (e.g., VoNR emergency calls not supported). This determination may be based on an emergency services support indicator for 3GPP access (EMC) that indicates support of emergency services in 5GS for 3GPP access. This indicator may include two bits that provide, for example, ‘0,0 to indicate emergency services are not supported, ‘0,1’ to indicate emergency services are supported in NR connected to 5GCN only, ‘1,0’ to indicate emergency services are supported in E-UTRA connected to 5GCN only, or ‘1,1’ to indicate emergency services are supported in NR connected to 5GCN and E-UTRA connected to 5GCN.

The operation flow/algorithmic structure 700 may further include, at 712, determining emergency fallback is supported in EUTRA. Thus, in this embodiment, the network only supports emergency services with EPS fallback, no N1 emergency services are supported.

The determination at 712 may be based on an emergency services fallback indicator for 3GPP access (EMF). This indicator may include two bits that provide, for example, ‘0,0 to indicate emergency services fallback is not supported, ‘0,1’ to indicate emergency services fallback is supported in NR connected to 5GCN only, ‘1,0’ to indicate emergency services fallback is supported in E-UTRA connected to 5GCN only, or ‘1,1’ to indicate emergency services fallback is supported in NR connected to 5GCN and E-UTRA connected to 5GCN.

The operation flow/algorithmic structure 700 may further include, at 716, enabling EUTRA/S1 capability in N1 mode. The EUTRA/S1 capability may be enabled even though the T3402 is active (for example, running and not expired). This may provide the UE with emergency services that would otherwise be compromised in the event EUTRA/S1 was disabled and no legacy CS networks were available.

In some embodiments, the EUTRA/S1 capabilities may be re-enabled at the time the emergency services are attempted. However, if the emergency services are available when a UE is camped, access to such services may be faster and more reliable.

In some embodiments, if information is available that indicates only EPS fallback for EMC is supported, the UE may not disable the S1 mode when registering on N1 mode.

FIG. 8 illustrates an operation flow/algorithmic structure 800 that may be used for NR emergency services failure in accordance with some embodiments. The operation flow/algorithmic structure 800 may be implemented by the UE 104 or 1000; or components thereof such as processors 1004.

The operation flow/algorithmic structure 800 may start at 804 with EUTRA/S1 being disabled. The T3402 timer may be started for 12 minutes. Further starting conditions may include no legacy radio access technologies being available (for example, 2G/3G fallback not being available).

The operation flow/algorithmic structure 800 may then include, at 808, determining that emergency services are supported in the N1 mode. This may be determined as discussed elsewhere herein.

The operation flow/algorithmic structure 800 may further include, at 812, detecting an emergency call failure in N1 mode. This may be detected when, for example, the UE uses VoNR for an emergency call that fails.

The operation flow/algorithmic structure 800 may further include, at 816, enabling EUTRA/S1 in N1 mode. The EUTRA capabilities may be re-enabled even though the T3402 timer is still active.

In this manner, the UE can retry the emergency services in fallback or as a voice over LTE (VoLTE) call after an NR emergency call fails.

In some embodiments, the operation flow/algorithmic structure 800 may further include, at 820, optionally retrying emergency call on other PLMNs, if available.

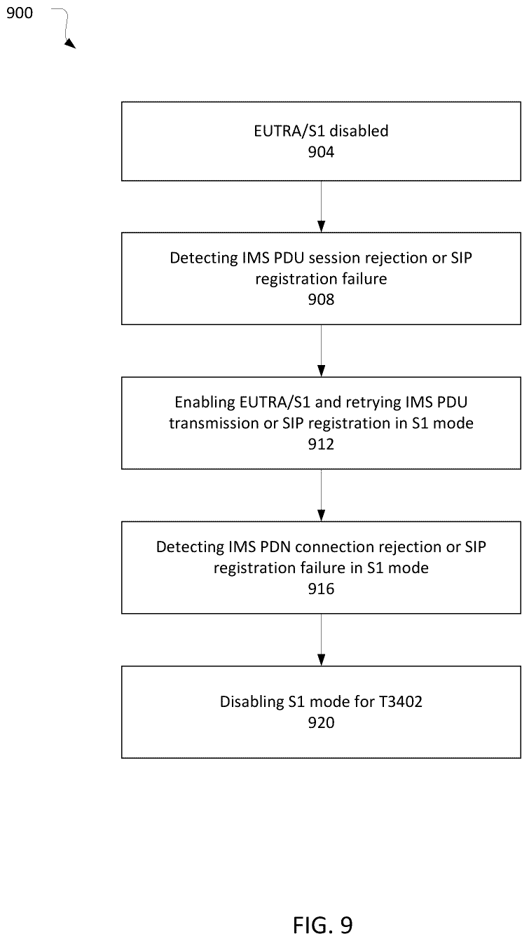

FIG. 9 illustrates an operation flow/algorithmic structure 900 that may be used for re-enabling S1 after a PDU rejection accordance with some embodiments. The operation flow/algorithmic structure 900 may be implemented by the UE 104 or 1000; or components thereof such as processors 1004.

The operation flow/algorithmic structure 900 may generally correspond to aspect 7 and may provide that if IMS services are available but IMS PDU session gets rejected or IMS SIP registration fails on 5G NR causing voice service unavailability for more than one minute, for example, then EUTRA may be re-enabled. If a similar rejection/failure is observed on EUTRA, then S1 mode may again be disabled and the UE may return to N1 mode.

The operation flow/algorithmic structure 900 may start at 904 with EUTRA/S1 being disabled. The T3402 timer may be started for 12 minutes. Further starting conditions may include no legacy radio access technologies being available (for example, 2G/3G fallback not being available) and IMS voice over 3GPP being supported in N1 mode.

The operation flow/algorithmic structure 900 may then include, at 908, detecting IMS PDU session rejection or SIP registration failure for IMS services on 5G NR. In some embodiments, the IMS PDU session rejection or SIP registration failure may only be detected if it causes voice services to be unavailable for more than a predetermined period of time (for example, more than one minute). The predetermined period of time may be established by comparing a back off timer to a predetermined threshold.

In some embodiments, the IMS PDU session rejection may be detected if an IMS PDU session, which may correspond to a 5G data bearer, is rejected a predetermined number of times (e.g., 5 times) with a cause value that indicates a UE-requested PDU session establishment procedure is not accepted by the network. In some embodiments, the cause value may be any of those listed in clause 6.4.1.4 of 3GPP TS 24.501 (for example, #38 Network Failure).

After detecting the IMS PDU session rejection or SIP registration failure at 908, the operation flow/algorithmic structure 900 may advance to enabling the EUTRA/S1 (even though the T3402 timer may still be active) and retrying S1 mode at 912. The UE may retry with an LTE IMS packet data network (PDN) connection and SIP registration via EUTRAN. The LTE IMS PDN connection may correspond to a 4G data bearer.

If, at 916, a similar LTE IMS PDN connection rejection or SIP registration failure in EUTRA is detected, the operation flow/algorithmic structure 900 may advance to disabling the S1 mode for the remainder of the T3402 timer at 920.

In this manner, the UE may be able to receive services in EUTRA/S1 if IMS services are not available in N1 mode due to temporary failures. If the UE is unable to receive services in EUTRA/S1, then the UE may have data services available in 5G.

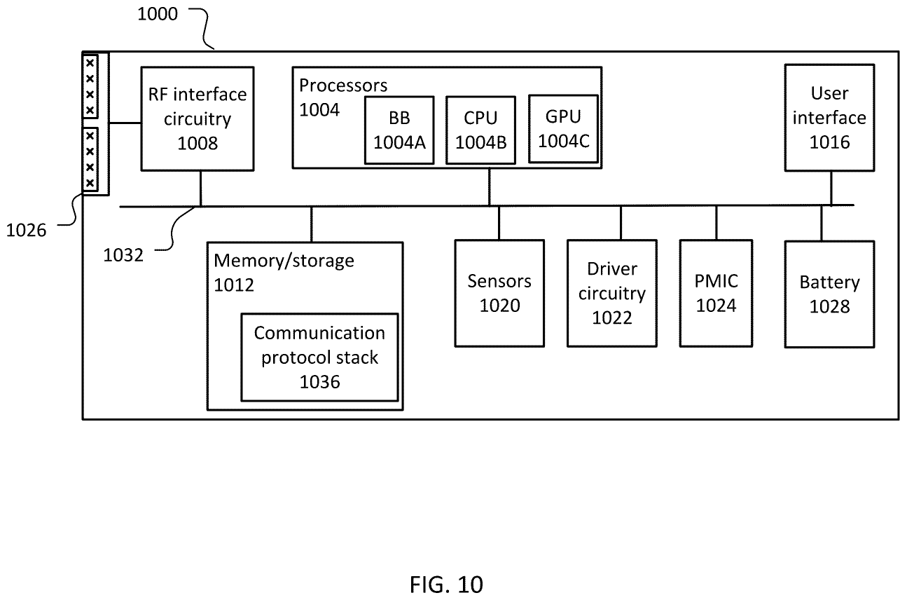

FIG. 10 illustrates an example UE 1000 in accordance with some embodiments. The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1000 may be a RedCap UE or NR-Light UE.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, optical connection, etc. that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various operations described herein. The memory/storage 1012 include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple-input, multiple-output communications. The antenna 1026 may include microstrip antennas, printed antennas fabricated on the surface of one or more printed circuit boards, patch antennas, phased array antennas, etc. The antenna 1026 may have one or more panels designed for specific frequency bands including bands in FR1 or FR2 .

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1000 may power down for brief intervals of time and thus save power. If there is no data traffic activity for an extended period of time, then the UE 1000 may transition off to an RRC Idle state, where it disconnects from the network and does not perform operations such as channel quality feedback, handover, etc. The UE 1000 goes into a very low power state and it performs paging where again it periodically wakes up to listen to the network and then powers down again. The UE 1000 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1028 may power the UE 1000, although in some examples the UE 1000 may be mounted deployed in a fixed location, and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

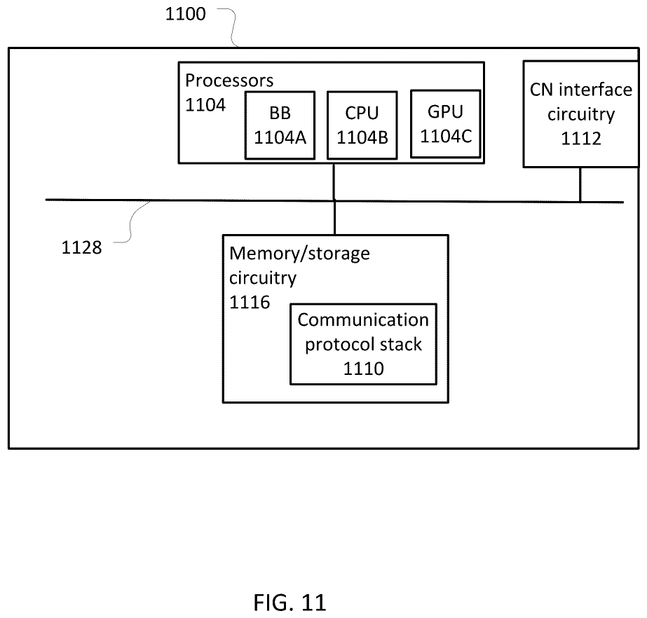

FIG. 11 illustrates a network node 1100 in accordance with some embodiments. The network node 1100 may include processors 1104, CN interface circuitry 1112, memory/storage circuitry 1116, and antenna structure 1126.

The components of the network node 1100 may be coupled with various other components over one or more interconnects 1128.

The processors 1104, memory/storage circuitry 1116 (including communication protocol stack 1110), and interconnects 1128 may be similar to like-named elements shown and described with respect to FIG. 10.

The CN interface circuitry 1112 may provide connectivity to devices that implement functions of a core network, for example, 5GC 104, using a 5GC-compatible network interface protocol such as carrier Ethernet protocols, or some other suitable protocol. Network connectivity may be provided to/from the network node 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method of operating a user equipment (UE), the method comprising: disabling an S1 interface; receiving a registration accept message via a first N1 interface through a next generation radio access network (NG-RAN), the registration accept message to indicate that Internet protocol (IP) multimedia subsystem (IMS) service over Third Generation Partnership Project (3GPP) access is not allowed and IMS service over non-3GPP is allowed; registering IMS service via a second N1 interface through a non-3GPP access network; and operating in an N1 mode using the second N1 interface.

Example 2 includes the method of example 1 or some other example herein, further comprising: starting a timer based on disabling the S1 interface; and operating in the N1 mode while the timer is running.

Example 3 includes the method of example 2 or some other example herein, wherein the timer is a T3402 timer.

Example 4 includes the method of example 2 or some other example herein, further comprising: detecting that the UE is out of a coverage area provided by the non-3GPP access network and the timer has expired; and transmitting, based on said detecting, a registration request via the first N1 interface to re-enable the S1 interface.

Example 5 includes the method of example 1 or some other example herein, further comprising: simultaneously maintaining the first N1 interface and the second N1 interface; accessing protocol data unit (PDU) or network slice session services via the first N1 interface; and accessing IMS services via the second N1 interface.

Example 6 includes a method of operating a UE, the method comprising: detecting a set of conditions that includes an S1 mode being disabled in a first public land mobile network (PLMN) that is a registered PLMN (RPLMN), a T3402 timer being active, Internet protocol (IP) multimedia subsystem (IMS) service over Third Generation Partnership Project (3GPP) access network not being available, and a second PLMN being available; and based on detecting the set of conditions, maintaining a disabled state of the S1 mode in the RPLMN until expiry of the T3402 timer, enabling S1 mode in the second PLMN, and sending a registration request for voice services to the second PLMN.

Example 7 includes the method of example 6 or some other example herein, wherein the second PLMN is an equivalent PLMN (EPLMN) with respect to the RPLMN, an equivalent home PLMN (EHPLMN) with respect to the RPLMN, or a preferred PLMN (PPLMN).

Example 8 includes the method of example 6 or some other example herein, further comprising: enabling the S1 mode for the RPLMN based on a determination that voice services are not available in the second PLMN and the T3402 timer has expired.

Example 9 includes a method of operating a UE, the method comprising: starting a timer and changing a usage setting of the UE from voice-centric to data-centric based on a determination that voice services are unavailable through one or more networks accessible by the UE; and changing the usage setting from data-centric to voice-centric based on an expiration of the timer.

Example 10 includes the method of example 9 or some other example herein, further comprising: determining Internet protocol (IP) multimedia subsystem (IMS) service over a non-Third Generation Partnership Project (3GPP) network is not available; and starting a timer based on said determining IMS services over a non-3PP network is not available.

Example 11 includes the method of example 9 or some other example herein, further comprising: determining voice services are unavailable through a public land mobile network (PLMN) accessible by the UE; and starting the timer based on said determining IMS services over a non-3GPP network is not available.

Example 12 includes the method of example 9 or some other example herein, further comprising: determining voice services are unavailable through a public land mobile network (PLMN) accessible by the UE; and starting the timer based on said determining IMS services over a non-3GPP network is not available.

Example 13 includes the method of example 9 or some other example herein, further comprising: determining voice services are unavailable through any public land mobile network (PLMN) accessible by the UE; and starting the timer based on said determining voice services are unavailable through any PLMN accessible by the UE.

Example 14 includes the method of example 9 or some other example herein, wherein the timer is set with a value that is less than a value of a T3402 timer.

Example 15 includes the method of example 9 or some other example herein, wherein the timer is a back-off timer.

Example 16 includes a method of operating a user equipment (UE), the method comprising: detecting a condition that includes: Internet protocol multimedia subsystem (IMS) voice service not being available over an S1 interface; a reject cause indicating evolved packet system (EPS) services are not allowed in a tracking area has been received or evolved universal terrestrial radio access (EUTRA) is not allowed; a UE-initiated detach for EPS services has occurred; or EUTRA capability has been disabled to prevent handover or cell reselection from a next generation-radio access network (NG-RAN) to an evolved universal terrestrial access network (E-UTRAN); and based on detecting the condition, keeping an S1 mode disabled.

Example 17 includes the method of example 16 or some other example herein, further comprising: detecting a NoEUTRADisablingin5GS information element (IE) to indicate a command to re-enable EUTRA; and discarding the command based on detecting the condition.

Example 18 includes the method of example 16 or some other example herein, further comprising: starting a timer upon disabling the S1 mode; and re-enabling the S1 mode based on an expiration of the timer.

Example 19 includes a method comprising: disabling evolved universal terrestrial access (EUTRA) capabilities; determining emergency services are not supported in an N1 mode; determining emergency fallback is supported in EUTRA; and re-enabling the EUTRA capabilities based on determining emergency services are not supported in the N1 mode and determining emergency fallback is supported in EUTRA.

Example 20 includes the method of example 19 or some other example herein, further comprising: re-enabling the EUTRA capabilities based on determining emergency services are not supported in the N1 mode and determining emergency fallback is supported in EUTRA while a T3402 timer is active.

Example 21 includes a method comprising: disabling evolved universal terrestrial access (EUTRA) capabilities; determining emergency services are supported in an N1 mode; detecting an emergency call failure in the N1 mode; and re-enabling the EUTRA capabilities based on determining emergency services are supported in the N1 mode and detecting the emergency call failure.

Example 22 includes the method of example 21 or some other example herein, further comprising: re-enabling the EUTRA capabilities based on determining emergency services are supported in the N1 mode and detecting the emergency call failure while a T3402 timer is active.

Example 23 includes the method of example 21 or some other example herein, further comprising: initiating a voice over long term evolution (VoLTE) emergency call after re-enabling the EUTRA capabilities.

Example 24 includes the method of example 21 or some other example herein, further comprising: detecting the emergency call failure with respect to a first public land mobile network (PLMN); and initiating an emergency call in a second PLMN based on said detecting the emergency call failure with respect to the first PLMN.

Example 25 includes a method comprising: disabling evolved universal terrestrial access (EUTRA) capabilities; detecting an Internet protocol multimedia subsystem (IMS) protocol data unit (PDU) is rejected a predetermined number of times or a session initiation protocol (SIP) registration fails; re-enabling the EUTRA capabilities based on detecting the IMS PDU is rejected the predetermined number of times or the SIP registration fails; and attempting an IMS packet data network (PDN) connection with S1 mode.

Example 26 includes the method of example 25 or some other example herein, further comprising: detecting IMS PDN connection rejection or SIP registration failure in the S1 mode; and disabling the EUTRA capabilities based on said detecting the IMS PDN connection rejection or SIP registration failure in the S1 mode.

Example 27 may include an apparatus comprising means to perform one or more elements of a method described in or related to any of examples 1-26, or any other method or process described herein.

Example 28 may include one or more non-transitory computer-readable media comprising instructions to cause an electronic device, upon execution of the instructions by one or more processors of the electronic device, to perform one or more elements of a method described in or related to any of examples 1-26, or any other method or process described herein.

Example 29 may include an apparatus comprising logic, modules, or circuitry to perform one or more elements of a method described in or related to any of examples 1-26, or any other method or process described herein.

Example 30 may include a method, technique, or process as described in or related to any of examples 1-26, or portions or parts thereof.

Example 31 may include an apparatus comprising: one or more processors and one or more computer-readable media comprising instructions that, when executed by the one or more processors, cause the one or more processors to perform the method, techniques, or process as described in or related to any of examples 1-26, or portions thereof.

Example 32 may include a signal as described in or related to any of examples 1-26, or portions or parts thereof.

Example 33 may include a datagram, information element, packet, frame, segment, PDU, or message as described in or related to any of examples 1-26, or portions or parts thereof, or otherwise described in the present disclosure.

Example 34 may include a signal encoded with data as described in or related to any of examples 1-26, or portions or parts thereof, or otherwise described in the present disclosure.

Example 35 may include a signal encoded with a datagram, IE, packet, frame, segment, PDU, or message as described in or related to any of examples 1-26, or portions or parts thereof, or otherwise described in the present disclosure.

Example 36 may include an electromagnetic signal carrying computer-readable instructions, wherein execution of the computer-readable instructions by one or more processors is to cause the one or more processors to perform the method, techniques, or process as described in or related to any of examples 1-26, or portions thereof.

Example 37 may include a computer program comprising instructions, wherein execution of the program by a processing element is to cause the processing element to carry out the method, techniques, or process as described in or related to any of examples 1-26, or portions thereof.

Example 38 may include a signal in a wireless network as shown and described herein.

Example 39 may include a method of communicating in a wireless network as shown and described herein.

Example 40 may include a system for providing wireless communication as shown and described herein.

Example 41 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause a user equipment (UE) to:
disable an S1 interface;
receive a registration accept message via a first N1 interface through a next generation radio access network (NG-RAN), the registration accept message to indicate that Internet protocol (IP) multimedia subsystem (IMS) service over Third Generation Partnership Project (3GPP) access is not allowed and IMS service over non-3GPP is allowed;
register IMS service via a second N1 interface through a non-3GPP access network; and
operate in an N1 mode using the second N1 interface.

2. The one or more non-transitory, computer-readable media of claim 1, wherein the instructions, when executed, further cause the UE to:
start a timer based on disabling the S1 interface.

3. The one or more non-transitory, computer-readable media of claim 2, wherein the instructions, when executed, further cause the UE to:
operate in the N1 mode while the timer is running.

4. The one or more non-transitory, computer-readable media of claim 3, wherein the timer is a T3402 timer.

5. The one or more non-transitory, computer-readable media of claim 3, wherein the instructions, when executed, further cause the UE to:
detect that the UE is out of a coverage area provided by the non-3GPP access network and the timer has expired; and
transmit, based on said detection that the UE is out of a coverage area provided by the non-3GPP access network and the timer has expired, a registration request via the first N1 interface to re-enable the S1 interface.

6. The one or more non-transitory, computer-readable media of claim 1, wherein the instructions, when executed, further cause the UE to:
simultaneously maintain the first N1 interface and the second N1 interface.

7. The one or more non-transitory, computer-readable media of claim 6, wherein the instructions, when executed, further cause the UE to:
access protocol data unit (PDU) or network slice session services via the first N1 interface.

8. The one or more non-transitory, computer-readable media of claim 6, wherein the instructions, when executed, further cause the UE to:
access IMS services via the second N1 interface.

9. A method of operating a UE, the method comprising:
starting a timer and changing a usage setting of the UE from voice-centric to data-centric based on a determination that voice services are unavailable through one or more networks accessible by the UE; and
changing the usage setting from data-centric to voice-centric based on an expiration of the timer.

10. The method of claim 9, further comprising:
determining Internet protocol (IP) multimedia subsystem (IMS) service over a non-Third Generation Partnership Project (3GPP) network is not available.

11. The method of claim 10, further comprising:
starting a timer based on said determining IMS service over a non-3PP network is not available.

12. The method of claim 9, further comprising:
determining voice services are unavailable through a public land mobile network (PLMN) accessible by the UE.

13. The method of claim 12, further comprising:
starting the timer based on said determining IMS service over a non-3GPP network is not available.

14. The method of claim 9, further comprising:
determining voice services are unavailable through any public land mobile network (PLMN) accessible by the UE.
starting the timer based on said determining voice services are unavailable through any PLMN accessible by the UE.

15. The method of claim 9, wherein the timer is set with a value that is less than a value of a T3402 timer.

16. The method of claim 9, wherein the timer is a back-off timer.

17. A user equipment (UE) comprising:
radio-frequency (RF) interface circuitry; and
processing circuitry coupled with the RF interface circuitry, the processing circuitry to:
detect a condition that includes: Internet protocol multimedia subsystem (IMS) voice service not being available over an S1 interface; a reject cause indicating evolved packet system (EPS) services are not allowed in a tracking area has been received or evolved universal terrestrial radio access (EUTRA) is not allowed; a UE-initiated detach for EPS services has occurred; or EUTRA capability has been disabled to prevent handover or cell reselection from a next generation-radio access network (NG-RAN) to an evolved universal terrestrial access network (E-UTRAN); and
based on detection of the condition, keep an S1 mode disabled.

18. The UE of claim 17, wherein the processing circuitry is further to:
detect a NoEUTRADisablingin5GS information element (IE) to indicate a command to re-enable EUTRA; and
discard the command based on detecting the condition.

19. The UE of claim 17, wherein the processing circuitry is further to:
start a timer upon disabling the S1 mode.

20. The UE of claim 19, wherein the processing circuitry is further to:
re-enable the S1 mode based on an expiration of the timer.
